(19) United States
(12) Patent Application Publication
(10) Pub. No.: US 2022/0114513 A1
(43) Pub. Date: Apr. 14, 2022

(54) METHOD AND SYSTEM FOR CONFIGURING A WORKFLOW

(71) Applicant: SIRIONLABS PTE. LTD., Singapore (SG)

(72) Inventors: Aditya Gupta, Gurugram (IN); Neha Sharma, Gurugram (IN); Ravi Verma, Gurugram (IN); Rahul Raman, Gurugram (IN); Ajay Agrawal, Gurugram (IN)

(73) Assignee: SIRIONLABS PTE. LTD., Singapore (SG)

(21) Appl. No.: 17/421,983

(22) PCT Filed: Jan. 13, 2020
(86) PCT No.: PCT/IB2020/050223

§ 371 Date: Jul. 9, 2021

(30) Foreign Application Priority Data
Jan. 11, 2019 (IN) 201911001461

(51) Int. Cl. G06Q 10/06

(52) U.S. Cl. CPC G06Q 10/0633; G06Q 10/06311

(57) ABSTRACT

A method (200) for configuring a workflow is described. The method (200) comprises initiating (202), by a workflow engine (122), a task in the workflow and identifying (210), by a rule engine (124), at least one upcoming task in the workflow based on data associated with at least one parameter of the task. The method (200) further comprises determining (212), by a task engine (126), at least one additional parameter of the identified at least one upcoming task and obtaining (214), by the task engine (126), data associated with the at least one additional parameter. The method (200) further comprises completing (216), by the task engine (126), the task based on the data associated with the at least one additional parameter.

### TECHNICAL FIELD

The present disclosure relates to methods and systems for configuring a workflow. More particularly, the present disclosure relates to methods and systems for configuring a workflow by obtaining data associated with at least one upcoming task in the workflow prior to completion of an ongoing task.

### BACKGROUND

Often, in businesses, there are several repetitive tasks to be implemented. In order to streamline a process of implementing the repetitive tasks, the businesses employ automated workflows. The automated workflows improve the efficiency of completion of a project by automating the implementation of the repetitive tasks in the project and further remove the risk of human error. The automated workflows are also helpful in scenarios where the workflows are complicated and involve multiple meetings, reports, tasks, and departments. The implementation of the automated workflows in such scenarios allows the easy management and monitoring of status of the workflow. With more and more businesses opting for the automated workflows, it becomes necessary to identify methods to increase the efficiency of the automated workflows.

### SUMMARY

This summary is provided to introduce concepts related to the present inventive subject matter. The summary is not intended to identify essential features of the claimed subject matter nor is it intended for use in determining or limiting the scope of the claimed subject matter. The embodiments described below are not intended to be exhaustive or to limit the disclosure to the precise forms disclosed in the following detailed description. Rather, the embodiments are chosen and described so that others skilled in the art may appreciate and understand the principles and practices of the present inventive subject matter.

In one aspect, the disclosure is directed towards a method for configuring a workflow. The method comprises initiating, by a workflow engine, a task in the workflow and identifying, by a rule engine, at least one upcoming task in the workflow based on data associated with at least one parameter of the initiated task. The method further comprises determining, by a task engine, at least one additional parameter of the identified at least one upcoming task and obtaining, by the task engine, data associated with the at least one additional parameter. The method further comprises completing, by the task engine, the task based on the data associated with the at least one additional parameter.

In another aspect, the disclosure is directed towards a control system for configuring a workflow. The control system includes a workflow engine, a rule engine, and a task engine, all communicably coupled to each other. The workflow engine is configured to initiate a task in the workflow. The rule engine is configured to identify at least one upcoming task in the workflow based on data associated with at least one parameter of the task. The task engine is configured to determine at least one additional parameter of the identified at least one upcoming task and obtain data associated with the at least one additional parameter. The task engine is further configured to complete the task based on the data associated with the at least one additional parameter.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation. Many changes and modifications within the scope of the present disclosure may be made without departing from the spirit thereof, and the disclosure includes all such modifications.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

FIG. 1 illustrates a block diagram of an exemplary workflow management system, in accordance with the embodiments of the present disclosure; and

FIG. 2 illustrates an exemplary method for configuring a workflow in the workflow management system of FIG. 1, in accordance with the embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Hereinafter, the preferred embodiments of the present disclosure will be described in conjunction with the accompanying drawings, it should be understood that the preferred embodiments described herein are only used to illustrate and explain the present disclosure and are not intended to limit the present disclosure.

References to “some embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in some embodiment” does not necessarily refer to the same embodiment.

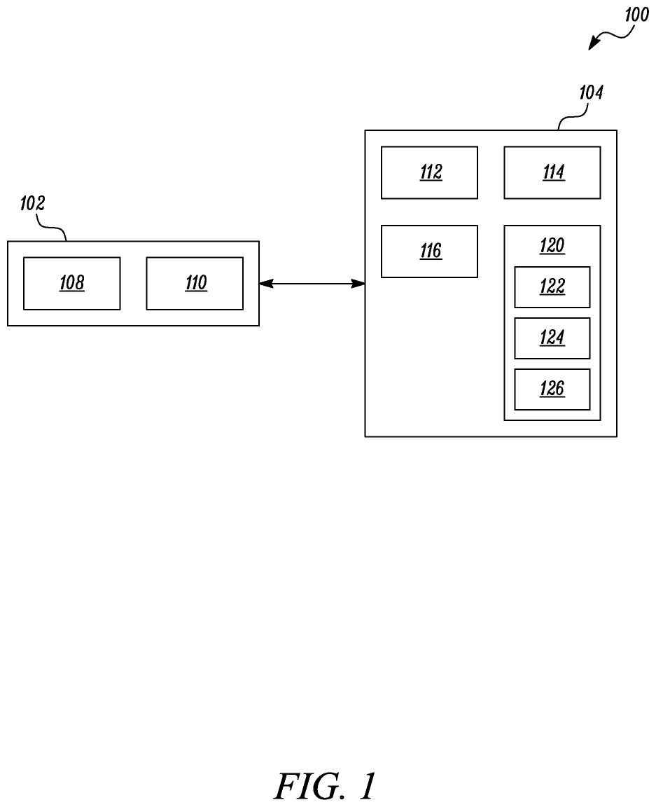

The present disclosure relates to a system and a method for configuring an automated workflow. FIG. 1 illustrates a block diagram of an exemplary workflow management system 100 for configuring an automated workflow, according to various embodiments of the present disclosure. The automated workflow may be employed for completion of a project and may include a created series of automated/semi-automated tasks. The task may be defined as a unit of work that may be assigned to one or more users (herein interchangeably referred to as one or more task owners) of the automated workflow. For the sake of brevity, the automated workflow may be hereinafter referred to as a workflow and the automated task may be hereinafter referred to as a task.

The workflow management system 100 depicted in FIG. 1 may be implemented in any suitable computing environment, such as one or more of, a desktop or a laptop computer, a computer server, or a mobile computing device, such as a mobile phone, a Personal Digital Assistant (PDA), or a smart phone. In addition, the workflow management system 100 may be combined into fewer systems than shown or divided into more systems than shown. The communication links depicted in FIG. 1 may be through wired or wireless connections and may be a part of a secured network, such as a local area network (LAN) and/or a combination of networks, such as LANs, WANs, MANs and/or the Internet.

The workflow management system 100 may include an input data source 102 and a control system 104. The input data source 102 may be configured to receive (i) a request to initiate a task in the workflow, (ii) data associated with at least one parameter of the task, (iii) request to complete the task, and (iv) data associated with at least one additional parameter of at least one upcoming task, from a user. The at least one upcoming task may represent any task that may occur later in the workflow. Similarly, the task (herein interchangeably referred to as active task, ongoing task, or current task) may represent a task which is initiated, but not yet completed, in the workflow. The input data source 102 may be further configured to transmit the received requests and the data from the user to the control system 104. In an embodiment, the input data source 102 may also be configured to store task IDs associated with tasks assigned to the user. The user to which a task is assigned may be herein interchangeably referred to as a task owner. The input data source 102 may be further configured to transmit a corresponding task ID of the task along with the requests for the initiation or completion of the task to the control system 104.

In an embodiment, the at least one parameter of the task may include any mandatory parameter, associated with the task, corresponding to which a data is required from the user. The data associated with the at least one parameter of the task may be a data associated with the at least one parameter of the task. In an example, the data may include a name, a number, email address, a date, or scanned document etc. For example, the task may be related to providing initial contract information and the at least one parameter associated with the task may be a logistic cost. In this case, the data associated with the logistic cost may be a number such as 20,000 INR. It may also be contemplated that these numbers are only illustrative and should not be construed as limiting in any manner.

Further, the at least one additional parameter of the at least one upcoming task may include any mandatory parameter, associated with the at least one upcoming task, corresponding to which a data is required from the user. The data associated with the at least one additional parameter of the at least one upcoming task may be a data associated with the at least one additional parameter of the at least one upcoming task. In an example, the data may include a name, a number, email address, a date, or scanned document etc. In an embodiment, the at least one additional parameter of the at least one upcoming task may be defined as pre-condition or pre-requisite for an upcoming task. In the example discussed above, the at least one upcoming task may be an approval from a finance head and the at least one additional parameter of the at least one upcoming task may be a contact detail of a finance head. In this case, the data associated with the contact detail of a finance head may be the email address of the finance head.

Further, the input data source 102 may be configured to receive (i) the at least one parameter of the task and (ii) the at least one additional parameter of the at least one upcoming task from the control system 104. The input data source 102 may be configured to display the received (i) the at least one parameter of the task and (ii) the at least one additional parameter of the at least one upcoming task to the user. The input data source 102 may be a mobile phone, a tablet or any other communication device. The input data source 102 may include an input unit 108 and an output unit 110. The input unit 108 may be a keypad, a touchpad, a scanner, a camera or any other input device. The output unit 110 may be a display device or any other output device.

The control system 104 may be configured to obtain the data associated with the at least one additional parameter of the at least one upcoming task in the workflow, prior to the completion of the task. The control system 104 may be a centralized system (which may be implemented on a server or a cloud server, etc.) connected to the various other components of the workflow management system 100 via a network (not shown), such as internet or intranet, etc. The control system 104 may include suitable logic, circuitry, and/or interfaces that are configured to control the various operations of the workflow management system 100.

The control system 104 may include an Input/Output unit 112 (hereinafter interchangeably referred to as I/O unit 112, input unit 112, or output unit 112), a communication unit 114, a memory unit 116, and a processor 120. The I/O unit 112 may be configured to communicate with the input data source 102 via the communication unit 114, to receive (i) the request to initiate the task in the workflow, (ii) the data associated with the at least one parameter of the task, (iii) the request to complete the task, and (iv) the data associated with the at least one additional parameter of the at least one upcoming task, from the user. The I/O unit 112 may further communicate with the input data source 102 via the communication unit 114, to transmit (i) the at least one parameter of the task and (ii) the at least one additional parameter of the at least one upcoming task. The communication unit 114 may include a modem, an ethernet card, or other similar devices, that enable the control system 104 to connect to the various components of the workflow management system 100.

The memory unit 116 may be configured to store a set of instructions that are executable by the workflow engine 122, a rule engine 124, and a task engine 126 to perform the predetermined operations. The memory unit 116 may be further configured to store data related to the workflow, including but not limited to, sequence of tasks in the workflow, task ID of each task in the workflow, identification information of a task owner of each task in the workflow, conditional rules associated with each task for determination of upcoming tasks in the workflow, and parameter(s)/additional parameter(s) of each task corresponding to which the data is required from the associated task owner. In an embodiment, the conditional rules may include a set of rules, associated with one or more parameters of the task, based on which an upcoming task is determined. The memory unit 116 may be further configured to store a set of field level rules associated with each task ID in the workflow. In an embodiment, the field level rules may include rules to validate the data such as, but not limited to, format, range etc., provided by the user. The memory unit 116 may include, but is not limited to, a Random-Access Memory (RAM), a Read Only Memory (ROM), a Hard Disk Drive (HDD), and a Secure Digital (SD) card.

The processor 120 may be configured to obtain the data associated with the at least one additional parameter of the at least one upcoming task in the workflow, prior to the completion of the task. In an embodiment, the processor 120 may include a workflow engine 122, a rule engine 124, and a task engine 126, communicably coupled to each other.

The workflow engine 122 may be configured to receive the request to initiate the task in the workflow from the input data source 102 via the I/O unit 112. In an embodiment, the request to initiate the task in the workflow may be generated by a user by selecting an option presented on the display of the input data source 102. The request to initiate the task may include the task ID corresponding to the task. The workflow engine 122 may be further configured to initiate the task in the workflow based on the received request. The workflow engine 122 may be further configured to receive the data associated with the at least one parameter of the task from the input data source 102 via the I/O unit 112. As discussed above, the at least one parameter of the task may include any mandatory parameter, associated with the task, corresponding to which a data is required from the user. In an embodiment, the data associated with the at least one parameter of the task may be provided by the user using the input unit 102. The data may be provided in a field corresponding to the at least one parameter displayed on the input data source 102. In an example, the workflow engine 122 may receive a request to initiate a task related to providing the initial contract information and the request may include the task ID of the task. The at least one parameter, in this example, may include a logistic cost. The workflow engine 122 may initiate the task upon receiving the request and receive a number, such as 20,000 INR, as a data associated with the logistic cost. For the sake of brevity, the examples discuss data related to only one parameter associated with the task. However, the discussions in the present disclosure may be applied to data related to a plurality of parameters associated with the task.

The workflow engine 122 may be further configured to provide the data associated with the at least one parameter and the task ID to the task engine 126 for validation of the data associated with the at least one parameter. In the example discussed above, the workflow engine 122 may be configured to provide the task ID and the data associated with the logistic cost (i.e. 20,000 INR) to the task engine 126 for validation.

The workflow engine 122 may further be configured to receive a request to complete the task from the input data source 102 via the I/O unit 112. In an embodiment, the request to complete the task may be generated by the user by selecting an option presented on the display of the input data source 102. In an exemplary embodiment, the request to complete the task may be obtained along with the data associated with the at least one parameter of the task. In the example discussed above, the workflow engine 122 may be configured to receive a request to complete the task of providing the initial contract information along with the data associated with the logistic cost. The workflow engine 122 may be further configured to provide the received request for completion of the task to the task engine 126.

The workflow engine 122 may also be configured to identify or extract conditional rules, associated with the task, from the memory unit 116. The workflow engine 122 may be further configured to provide the conditional rules associated with the task along with the data associated with the at least one parameter of the task to the rule engine 124. In the example discussed above, the workflow engine 122 may be configured to provide the conditional rules associated with the task of providing initial contract information and the data associated with the logistic cost (i.e. 20,000 INR) to the rule engine 124. In this example, the conditional rule may indicate that if the logistic cost is greater than 10,000 INR, an additional approval from a legal head is also required along with the approval from the finance head.

The rule engine 124 may be configured to determine the at least one upcoming task based on the conditional rules and the data associated with the at least one parameter of the task provided by the workflow engine 122. In an embodiment, the rule engine 124 may be configured to obtain the conditional rules and the data associated with the at least one parameter of the task from the workflow engine 122 and evaluate the data associated with the at least one parameter of the task in accordance with the conditional rules to determine the at least one upcoming task. The rule engine 124 may further be configured to provide a task ID of the at least one upcoming task to the task engine 126. In the example discussed above, the rule engine 124 evaluates the data associated with the logistic cost (i.e. 20,000 INR) in accordance with the conditional rule and determines that the logistic cost is greater than 10,000 INR and hence, an additional approval from a legal head is also required along with the approval from the finance head. The rule engine 124 may then determine that the upcoming task is approval from the legal head and the approval from the finance head.

The task engine 126 may be configured to validate the data associated with the at least one parameter of the task. In an embodiment, the task engine 126 may be configured to obtain the data associated with the at least one parameter and the task ID of the task. The task engine 126 may further be configured to validate the data associated with the at least one parameter of the task, based on the set of field level rules stored in the memory unit 116. In an embodiment, the task engine 126 may be configured to extract the field level rules associated with the task based on the task ID and validate the data associated with the at least one parameter of the task. In an exemplary embodiment, the task engine 126 may validate whether a format of the data associated with the at least one parameter of the task matches the required format. In another example, the task engine 126 may validate other conditions related to the data associated with the at least one parameter of the task, such as whether the export date is greater than the effective date etc. The task engine 126 may be further configured to generate a failure message when the data associated with the at least one parameter does not comply with the field level rules. In such cases, the task engine 126 may control the display of the failure message on the input data source 102 and prompts the user to re-enter the data.

The task engine 126 may be further configured to identify/determine the at least one additional parameter of the at least one upcoming task. In an embodiment, the task engine 126 may be configured to obtain a task ID of the at least one upcoming task from the rule engine 124 and determine the at least one additional parameter of the at least one upcoming task based on the stored additional parameters associated with the task ID in the memory unit 116. The task engine 126 may further be configured to control a display of the at least one additional parameter on the input data source 102, to receive/obtain the data associated with the at least one additional parameter from user via the input data source 102 and the I/O unit 112. In an embodiment, the data associated with the at least one additional parameter may be provided by the user using the input unit 102. The data may be provided in a field corresponding to the at least one additional parameter displayed on the input data source 102.

In an embodiment, the task engine 126 may be configured to control the display of the input data source 102 to hide the at least one additional parameter from the user until the request for the completion of the task is received and the at least one additional parameter is determined. In an alternate embodiment, the task engine 126 may be configured to control the display of the input data source 102 to display the at least one additional parameter as an optional (or non-mandatory) parameter to the user until the request for the completion of the task is received and the at least one additional parameter is determined. The optional parameter may include any parameter corresponding to which a data is not mandatorily required from the user during a task. In an further embodiment, the task engine 126 may be configured to control the display of the input data source 102 to hide the at least one additional parameter from the user until the request for the completion of the task is received and the at least one additional parameter is determined. Once the request for the completion of the task is received from the user and the at least one additional parameter is determined, the task engine 126 may be configured to control the display of the at least one additional parameter as a mandatory parameter to the user.

The task engine 126 may be configured to validate the obtained data associated with the at least one additional parameter of the at least one upcoming task based on the field level rules associated with the at least one additional parameter of the at least one upcoming task. The task engine 126 may be further configured to obtain the request for the completion of the task and defer the completion of the task until the data associated with the at least one additional parameter of the at least one upcoming task is validated. The task engine 126 may be further configured to complete the task, upon validating the data associated with the at least one additional parameter of the at least one upcoming task.

While the workflow engine 122, the rule engine 124, and the task engine 126 are depicted as a part of the processor 120, it may be implemented as a system separate from the processor 120. The workflow engine 122, the rule engine 124, and the task engine 126 may be configured to be executable with the processor 120. The processor 120 may include one or more microprocessors, microcontrollers, DSPs (digital signal processors), state machines, logic circuitry, or any other device or devices that process information based on operational or programming instructions. The processor 120 may be implemented using one or more controller technologies, such as Application Specific Integrated Circuit (ASIC), Reduced Instruction Set Computing (RISC) technology, Complex Instruction Set Computing (CISC) technology, etc. The processor 120 may be configured to execute the instructions stored in the memory unit 116 to perform the predetermined operations. In an embodiment, the processor 120 may constitute a workflow engine for configuring the workflow.

### INDUSTRIAL APPLICABILITY

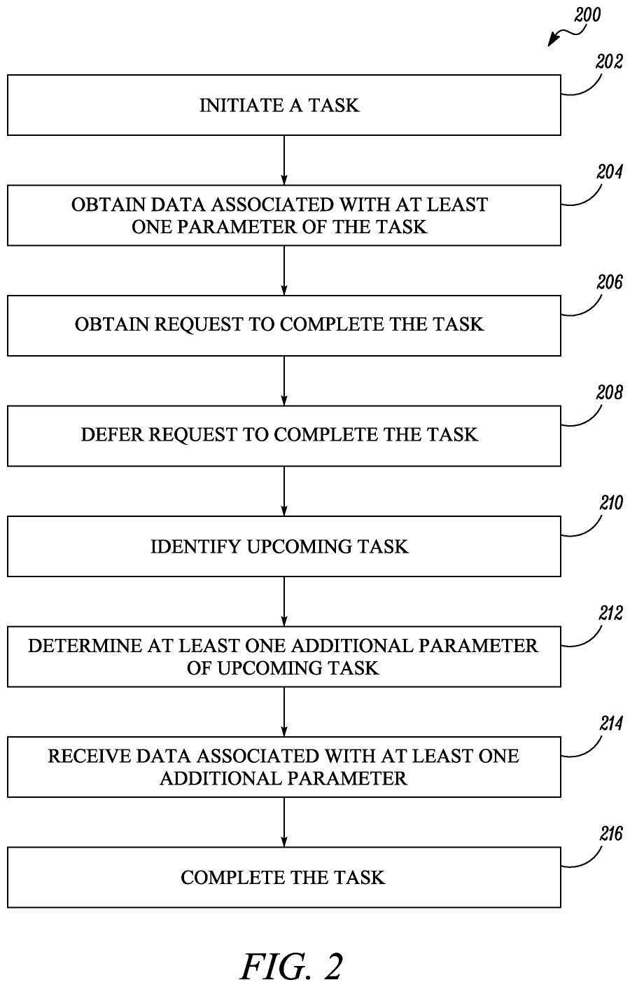

FIG. 2 illustrates an exemplary method 200 for configuring a workflow, in accordance with the concepts of the present disclosure. The method 200 is performed by the workflow management system 100 of the present disclosure.

Initially, the workflow engine 122 receives the request to initiate the task in the workflow from the input data source 102 via the I/O unit 112. The request to initiate the task includes the task ID corresponding to the task. At step 202, the workflow engine 122 initiates the task in the workflow based on the received request. The workflow engine 122 also receives the data associated with the at least one parameter of the task from the input data source 102 via the I/O unit 112. The data associated with the at least one parameter is provided by the user using the input unit 102. The data is provided in a field corresponding to the at least one parameter displayed on the input data source 102. Further, the workflow engine 122 receives a request to complete the task. In an exemplary embodiment, the request to complete the task is obtained along with the data associated with the at least one parameter of the task. In an embodiment, the user generates the request to initiate or complete the task by selecting an option displayed on the input data source 102.

Upon initiating the task, the workflow engine 122 provides the data associated with the at least one parameter and the task ID to the task engine 126 for validation of the data associated with the at least one parameter. The workflow engine 122 further provides the received request for completion of the task to the task engine 126. The workflow engine 122 also provides the conditional rules associated with the task along with the data associated with the at least one parameter of the task to the rule engine 124.

At step 204, the task engine 126 obtains the data associated with the at least one parameter and the task ID of the task from the workflow engine 122. Further, the task engine 126 obtains the request to complete the task from the workflow engine 122 at step 206. In an embodiment, the request to complete the task is received along with the data associated with the at least one parameter and the task ID of the task.

At step 208, the task engine 126 defers the completion of the task. The task engine 126 proceeds to validating the data associated with the at least one parameter of the task, based on the set of field level rules stored in the memory unit 116.

At step 210, the rule engine 124 obtains the conditional rules and the data associated with the at least one parameter of the task from the workflow engine 122 and identifies the at least one upcoming task based on the obtained data. The rule engine 124 further provides a task ID of the at least one upcoming task to the task engine 126. In an embodiment, the step 210 may occur in parallel or prior to the steps 204, 206 and/or 208.

At step 212, the task engine 126 identifies/determines the at least one additional parameter of the at least one upcoming task upon obtaining the task ID of the at least one upcoming task. In an embodiment, the task engine 126 identifies/determines the at least one additional parameter of the at least one upcoming task based on the stored additional parameters associated with the task ID in the memory unit 116. The task engine 126 further controls the display of the at least one additional parameter on the input data source 102. In an embodiment, the task engine 126 displays the at least one additional parameter to the user upon obtaining the request to complete the task and determination of the at least one parameter of the upcoming task. The at least one additional parameter is not displayed or displayed as an optional parameter to the user prior to the request to complete the task and determination of the at least one parameter of the upcoming task.

At step 214, the task engine 126 obtains or receives the data associated with the at least one additional parameter of the at least upcoming task from the user via the input data source 102 and the I/O unit 112. In an embodiment, the data associated with the at least one additional parameter is provided by the user using the input unit 102. The data is provided in a field corresponding to the at least one additional parameter displayed on the input data source 102. The task engine 126 further validates the obtained data associated with the at least one additional parameter of the at least one upcoming task based on the field level rules associated with the at least one additional parameter of the at least one upcoming task.

At 216, the task engine 126 completes the task based on the obtained data associated with the at least one additional parameter of the at least one upcoming task. In an embodiment, the task engine 126, upon validating the data associated with the at least one additional parameter of the at least one upcoming task, completes the task. In an embodiment, the task engine 126 defers the completion of the task until the data associated with the at least one additional parameter is validated.

The workflow management system 100 of the present disclosure reduces the unnecessary delay introduced in the workflows by requesting the required data from the users well in advance. The workflow management system 100 of the present disclosure works efficiently for the conditional workflows as well, where the upcoming tasks are determined based on the data provided in an ongoing task. For conditional workflows, the workflow management system 100 identifies and obtains the data required in the upcoming tasks during the determination of the upcoming tasks and prior to the completion of the ongoing task. This results in completion of all tasks in the workflow in a timely manner without having to wait for the required inputs from the user at any stage.

Moreover, the workflow management system 100 requests only the mandatory data from the user that is determined based on the upcoming tasks, rather than having the user provide all sorts of data that may or may not be used later in the workflow. This results in further reducing the time required to complete the tasks in the workflow.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof. It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

While aspects of the present disclosure have been particularly shown, and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

We claim:

1. A method (200) for configuring a workflow, the method comprising:
initiating (202), by a workflow engine (122), a task in the workflow;
identifying (210), by a rule engine (124), at least one upcoming task in the workflow based on data associated with at least one parameter of the task;
determining (212), by a task engine (126), at least one additional parameter of the identified at least one upcoming task;
obtaining (214), by the task engine (126), data associated with the at least one additional parameter; and
completing (216), by the task engine (126), the task based on the data associated with the at least one additional parameter.

2. The method as claimed in claim 1, further comprising:
validating, by the task engine (126), the data associated with the at least one additional parameter prior to the completion of the task.

3. The method as claimed in claim 2, further comprising:
obtaining (206), by the task engine (126), a request to complete the task; and
deferring (208), by the task engine (126), the request to complete the task, wherein the request to complete the task is deferred until the data associated with the at least one additional parameter is validated.

4. The method as claimed in claim 3, further comprising:
controlling, by the task engine (126), a display of the at least one additional parameter to a user, wherein the at least one additional parameter is displayed to the user upon obtaining the request to complete the task.

5. The method as claimed in claim 4, wherein the at least one additional parameter is displayed to the user as an optional parameter prior to obtaining the request to complete the task.

6. A control system (104) for configuring a workflow, the control system (104) comprising:
a workflow engine (122) configured to initiate a task in the workflow;
a rule engine (124) communicably coupled to the workflow engine, the rule engine configured to identify at least one upcoming task in the workflow based on data associated with at least one parameter of the task; and
a task engine (126) communicably coupled to the workflow engine and the rule engine, the task engine configured to:
determine at least one additional parameter of the identified at least one upcoming task;
obtain data associated with the at least one additional parameter; and
complete the task based on the data associated with the at least one additional parameter.

7. The control system (104) as claimed in claim 6, wherein the task engine (126) is further configured to validate the data associated with the at least one additional parameter prior to the completion of the task.

8. The control system (104) as claimed in claim 7, wherein the task engine (126) is further configured to:
obtain a request to complete the task; and
defer the request to complete the task, wherein the request to complete the task is deferred until the data associated with the at least one additional parameter is validated.

9. The control system (104) as claimed in claim 8, wherein the task engine (126) is further configured to:
control a display of the at least one additional parameter to a user, wherein the at least one additional parameter is displayed to the user upon obtaining the request to complete the task.

10. The control system (104) as claimed in claim 9, wherein the at least one additional parameter is displayed as an optional parameter to the user prior to obtaining the request to complete the task.
